(19) United States
(12) Patent Application Publication
(10) Pub. No.: US 2018/0174189 A1
(43) Pub. Date: Jun. 21, 2018

(54) METHODS AND SYSTEMS FOR DETECTING GEOGRAPHIC AREAS HAVING ELEVATED SUPPLY AND DEMAND LEVELS

(71) Applicant: Groupon, Inc., Chicago, IL (US)

(72) Inventor: Anthony JOSEPH, Bellevue, WA (US)

(21) Appl. No.: 15/847,482

(22) Filed: Dec. 19, 2017

Related U.S. Application Data
(60) Provisional application No. 62/436,270, filed on Dec. 19, 2016.

(51) Int. Cl. G06Q 30/02; H04W 4/021; H04W 4/02; H04W 4/20; H04L 29/08

(52) U.S. Cl. CPC G06Q 30/0261; H04W 4/021; H04W 4/023; H04W 4/206; H04W 80/12; G06Q 30/0267; G06Q 30/0205; G06Q 30/0201; H04L 67/18

(57) ABSTRACT

Various methods are provided for identifying geographic areas having elevated supply and demand levels based on an elevated number of service providers and mobile devices in a geographic area utilizing location services. One example method may comprise identifying a geographic region comprising a pre-defined number of merchant devices, receiving location data associated with a plurality of mobile devices, determining that the number of mobile devices meets a predefined threshold number of mobile devices required in a particular area for the particular area to be considered hot, and classifying the geographic region, comprising both the pre-defined number of merchant devices and at least the predefined threshold number of mobile devices required for the particular area to be considered hot, as a hot zone while those numbers continue to meet the predefined threshold number of mobile devices required in a particular area for the particular area to be considered hot.

### CROSS-REFERENCE TO RELATED APPLICATIONS

This application claims benefit under 35 USC 119(e) of U.S. provisional Application No. 62/436,270, filed Dec. 19, 2016, the entire content of which is incorporated herein by reference.

### TECHNOLOGICAL FIELD

Example embodiments of the present invention relate generally to utilizing location services and, more particularly, to methods and systems for identifying geographic areas having elevated supply and demand levels based on the number of service providers and mobile devices in a geographic area.

### BACKGROUND

The applicant has discovered problems with current methods, systems, and apparatuses for utilizing location-based services for demand and/or supply identification. Through applied effort, ingenuity, and innovation, Applicant has solved many of these identified problems by developing a solution that is embodied by the present invention, which is described in detail below.

### BRIEF SUMMARY

Accordingly, a method, apparatus, and computer program to classify particular geographic regions as hot zones, for example, indicative of increased supply and demand. Example embodiments may include methods, systems, apparatuses, and the like that identify an elevated supply signal via the detection of geographic regions comprising a plurality of merchants and identify an elevated demand signal via monitoring and/or detecting and filtering location services data (e.g., GPS data) those geographic regions having a number of mobile devices that meet a predefined threshold to determine, for example, an overlap identifying a hot zone.

In some embodiments, a method may be provided for identifying geographic areas having elevated supply and demand levels based on an elevated number of service providers and mobile devices in a geographic area utilizing location services, the method comprising identifying a geographic region comprising a pre-defined number of merchant devices, receiving location data associated with a plurality of mobile devices, determining that the number of the plurality of mobile devices that are located within an area located within at least the geographic region comprising the pre-defined number of merchant devices meets a predefined threshold number of mobile devices required in a particular area for the particular area to be considered hot, and classifying the geographic region, comprising both the pre-defined number of merchant devices and the area meeting at least the predefined threshold number of mobile devices required in a particular area for the particular area to be considered hot, as a hot zone while the number of the plurality of mobile devices that are located within the continues to meet the predefined threshold number of mobile devices required in a particular area for the particular area to be considered hot.

In some embodiments, the identification of the geographic region comprises accessing first location data associated a first merchant device, accessing second location data associated with a second merchant device, and determining a distance between the first location data and the second location data, and determining that the distance is within a predefined threshold distance required for the identification of the geographic area. In some embodiments, the determination comprises receiving first location data, identifying whether the first location data is located within any of a plurality of the geographic regions, in an instance in which the first location data is located within one of the plurality of geographic regions, incrementing a counter associated with the geographic region, determining if the counter meets the predefined threshold, and in an instance in which the counter has meet the predefined threshold, classifying the geographic region.

In some embodiments, the determination comprises upon identification of at least one the geographic region, identifying a number of mobile devices within the at least one geographic region, in an instance in which the number of mobile devices within the at least one geographic threshold fails to meet the predefined threshold, monitoring for additional mobile device, upon identification of a new mobile device within the at least one geographic regions, receiving new location data, increment a counter associated with the number of mobile devices with the at least one geographic regions, iterate the identification, monitoring, receiving and incrementing steps, and in an instance in which the number of mobile devices within the at least one geographic threshold meets the predefined threshold, classifying the geographic region

In some embodiments, the determination comprises accessing first location data associated with a first mobile device, accessing an aggregation queue storing location data associated with each of the plurality of mobile devices, determining a number mobile devices located within a threshold distance to the first mobile device, and in an instance in which the number of mobile devices within the at least one geographic threshold meets the predefined threshold, classifying the geographic region.

In some embodiments, the method may further comprise identifying promotions associated with merchants within hot zone, send push notifications alerting a mobile device to available promotions related to nearby products, services, experiences, or events. In some embodiments, the method may further comprise determining which of a plurality of promotions to provide to a first mobile device and to a second mobile device, while observing availability limitations of each merchant.

In some embodiments, the method may further comprise monitoring the number of the plurality of mobile devices located within the geographic regions classified as a hot zone, and upon a determination that the number of the plurality of mobile devices that are located within the geographic area falls below or fails to meet the predefined threshold number of mobile devices required in the particular area for the particular area to be considered the hot zone, declassifying the geographic region.

In some embodiments, a computer program product may be provided for identifying geographic areas having elevated supply and demand levels based on an elevated number of service providers and mobile devices in a geographic area utilizing location services, the computer program product comprising at least one non-transitory computer-readable storage medium having computer-executable program code instructions stored therein, the computer-executable program code instructions comprising program code instructions for identifying a geographic region comprising a pre-defined number of merchant devices, receiving location data associated with a plurality of mobile devices, determining that the number of the plurality of mobile devices that are located within an area located within at least the geographic region comprising the pre-defined number of merchant devices meets a predefined threshold number of mobile devices required in a particular area for the particular area to be considered hot, and classifying the geographic region, comprising both the pre-defined number of merchant devices and the area meeting at least the predefined threshold number of mobile devices required in a particular area for the particular area to be considered hot, as a hot zone while the number of the plurality of mobile devices that are located within the continues to meet the predefined threshold number of mobile devices required in a particular area for the particular area to be considered hot.

In some embodiments, the identification of the geographic region comprises accessing first location data associated a first merchant device, accessing second location data associated with a second merchant device, and determining a distance between the first location data and the second location data, and determining that the distance is within a predefined threshold distance required for the identification of the geographic area.

In some embodiments, the determination comprises receiving first location data, identifying whether the first location data is located within any of a plurality of the geographic regions, in an instance in which the first location data is located within one of the plurality of geographic regions, incrementing a counter associated with the geographic region, determining if the counter meets the predefined threshold, and in an instance in which the counter has meet the predefined threshold, classifying the geographic region.

In some embodiments, the determination comprises upon identification of at least one the geographic region, identifying a number of mobile devices within the at least one geographic region, in an instance in which the number of mobile devices within the at least one geographic threshold fails to meet the predefined threshold, monitoring for additional mobile device, upon identification of a new mobile device within the at least one geographic regions, receiving new location data, increment a counter associated with the number of mobile devices with the at least one geographic regions, iterate the identification, monitoring, receiving and incrementing steps, and in an instance in which the number of mobile devices within the at least one geographic threshold meets the predefined threshold, classifying the geographic region.

In some embodiments, the determination comprises accessing first location data associated with a first mobile device, accessing an aggregation queue storing location data associated with each of the plurality of mobile devices, determining a number mobile devices located within a threshold distance to the first mobile device, and in an instance in which the number of mobile devices within the at least one geographic threshold meets the predefined threshold, classifying the geographic region.

In some embodiments, the computer-executable program code instructions further comprise program code instructions for identifying promotions associated with merchants within hot zone, send push notifications alerting a mobile device to available promotions related to nearby products, services, experiences, or events.

In some embodiments, the computer-executable program code instructions further comprise program code instructions for determining which of a plurality of promotions to provide to a first mobile device and to a second mobile device, while observing availability limitations of each merchant.

In some embodiments, the computer-executable program code instructions further comprise program code instructions for monitoring the number of the plurality of mobile devices located within the geographic regions classified as a hot zone, and upon a determination that the number of the plurality of mobile devices that are located within the geographic area falls below or fails to meet the predefined threshold number of mobile devices required in the particular area for the particular area to be considered the hot zone, declassifying the geographic region.

In some embodiments, an apparatus may be provided for identifying geographic areas having elevated supply and demand levels based on an elevated number of service providers and mobile devices in a geographic area utilizing location services, the apparatus comprising at least one processor and at least one memory including computer program code, the at least one memory and the computer program code configured to, with the processor, cause the apparatus to at least identify a geographic region comprising a pre-defined number of merchant devices, receive location data associated with a plurality of mobile devices, determine that the number of the plurality of mobile devices that are located within an area located within at least the geographic region comprising the pre-defined number of merchant devices meets a predefined threshold number of mobile devices required in a particular area for the particular area to be considered hot, and classify the geographic region, comprising both the pre-defined number of merchant devices and the area meeting at least the predefined threshold number of mobile devices required in a particular area for the particular area to be considered hot, as a hot zone while the number of the plurality of mobile devices that are located within the continues to meet the predefined threshold number of mobile devices required in a particular area for the particular area to be considered hot.

In some embodiments, the identification of the geographic region comprises accessing first location data associated a first merchant device, accessing second location data associated with a second merchant device, and determining a distance between the first location data and the second location data, and determining that the distance is within a predefined threshold distance required for the identification of the geographic area.

In some embodiments, the determination comprises receiving first location data, identifying whether the first location data is located within any of a plurality of the geographic regions, in an instance in which the first location data is located within one of the plurality of geographic regions, incrementing a counter associated with the geographic region, determining if the counter meets the predefined threshold, and in an instance in which the counter has meet the predefined threshold, classifying the geographic region.

In some embodiments, the determination comprises upon identification of at least one the geographic region, identifying a number of mobile devices within the at least one geographic region, in an instance in which the number of mobile devices within the at least one geographic threshold fails to meet the predefined threshold, monitoring for additional mobile device, upon identification of a new mobile device within the at least one geographic regions, receiving new location data, increment a counter associated with the number of mobile devices with the at least one geographic regions, iterate the identification, monitoring, receiving and incrementing steps, and in an instance in which the number of mobile devices within the at least one geographic threshold meets the predefined threshold, classifying the geographic region.

In some embodiments, the determination comprises accessing first location data associated with a first mobile device, accessing an aggregation queue storing location data associated with each of the plurality of mobile devices, determining a number mobile devices located within a threshold distance to the first mobile device, and in an instance in which the number of mobile devices within the at least one geographic threshold meets the predefined threshold, classifying the geographic region.

In some embodiments, the at least one memory and the computer program code are further configured to, with the processor, cause the apparatus to identify promotions associated with merchants within hot zone, send push notifications alerting a mobile device to available promotions related to nearby products, services, experiences, or events.

In some embodiments, the at least one memory and the computer program code are further configured to, with the processor, cause the apparatus to determine which of a plurality of promotions to provide to a first mobile device and to a second mobile device, while observing availability limitations of each merchant.

In some embodiments, the at least one memory and the computer program code are further configured to, with the processor, cause the apparatus to monitor the number of the plurality of mobile devices located within the geographic regions classified as a hot zone, and upon a determination that the number of the plurality of mobile devices that are located within the geographic area falls below or fails to meet the predefined threshold number of mobile devices required in the particular area for the particular area to be considered the hot zone, declassify the geographic region.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain example embodiments of the present disclosure in general terms, reference will now be made to the accompanying drawings, which are not necessarily drawn to scale, and wherein:

FIG. 1 illustrates an example system within which embodiments of the present invention may operate;

FIG. 2 illustrates a block diagram showing an example device for implementing an event detection system using special-purpose circuitry in accordance with some exemplary embodiments of the present invention;

FIG. 3 illustrates an example data flow among a consumer device, a server, and a merchant device in accordance with some exemplary embodiments of the present invention;

FIG. 4 illustrates an example data flow among a consumer device, a server, and a merchant device in accordance with some exemplary embodiments of the present invention;

FIG. 5 illustrates a flow diagram depicting an exemplary method in accordance with some exemplary embodiments of the present invention;

FIG. 6 illustrates a flow diagram depicting an exemplary method in accordance with some exemplary embodiments of the present invention;

FIG. 7 illustrates a flow diagram depicting an exemplary method in accordance with some exemplary embodiments of the present invention.

### DETAILED DESCRIPTION

### Overview

Various embodiments of the present invention are directed to improved apparatuses, methods, and computer readable media for identifying geographic regions comprised of, for example, a plurality of merchants and, for example, geo-fencing the geographic regions.

Various embodiments may then be configured for utilizing location information received from mobile devices to identify demand levels within the geo-fenced geographic region. Demand levels can be detected, monitored, and stored continuously and in real-time. The demand levels within a particular geo-fenced geographic regions may be used, for example, to identify those areas that could support additional supply. That is, various embodiments may be configured to identify those areas and times in which additional supply may be supported, which may aid, for example, a salesperson in prioritizing new business opportunities.

In some embodiments, improved apparatuses, methods, and computer readable media may be configured for monitoring and/or detecting and filtering location services data to identify where and/or when a congregation of mobile devices meets or exceeds a pre-defined threshold of mobile devices in a particular geographic area. In some exemplary embodiments, improved apparatuses, methods, and computer readable media may be configured for classifying particular geographic regions as hot zones, for example, indicative of increased supply and demand in the event that, for example, a number of the plurality of mobile devices within a particular geographic region meets a pre-defined threshold of mobile devices required in the particular geographic region for the particular geographic regions to be considered a hot zone.

In this regard, embodiments of the present invention provide systems, devices, and frameworks for receiving location information from both merchant devices and mobile devices, and subsequently taking action in accordance therewith. For example, send push notifications, for example, letting consumers know that a relevant promotion for a merchant that has been identified meeting their profile is nearby.

Embodiments further describe techniques and processes for utilizing identified hot zones in novel manners. For example, upon detection that a mobile device is located within a hot zone, embodiments may generate push notifications alerting a user to promotions related to available and nearby products, services, experiences, and/or events, or the like. Further embodiments include techniques for programmatically defining which of a plurality of available and nearby products, services, experiences, and/or events additional (e.g., new or nearby) mobile devices should be notified about. Moreover, in some exemplary embodiments, preceding the generation and transmission of push notifications, embodiments may determine which of a plurality of promotions to provide to a first mobile device, a second mobile device, etc. such that each mobile device receives a relevant promotion, system profit is maximized while observing the limitations of each merchant's availability.

### Definitions

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As used herein, the terms “data,” “content,” “information,” and similar terms may be used interchangeably to refer to data capable of being transmitted, received, and/or stored in accordance with embodiments of the present invention. Thus, use of any such terms should not be taken to limit the spirit and scope of embodiments of the present invention. Further, where a computing device is described herein to receive data from another computing device, it will be appreciated that the data may be received directly from the another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to the another computing device or may be sent indirectly via one or more intermediary computing devices, such as, for example, one or more servers, relays, routers, network access points, base stations, hosts, and/or the like.

As used herein, the term “promotion and marketing service” may include a service that is accessible via one or more computing devices and that is operable to provide promotion and/or marketing services on behalf of one or more providers that are offering one or more instruments that are redeemable for goods, services, experiences and/or the like. In some examples, the promotion and marketing service may take the form of a redemption authority, a payment processor, a rewards provider, an entity in a financial network, a promoter, an agent and/or the like. As such, the service is, in some example embodiments, configured to present one or more promotions via one or more impressions, accept payments for promotions from consumers, issue instruments upon acceptance of an offer, participate in redemption, generate rewards, provide a point of sale device or service, issue payments to providers and/or or otherwise participate in the exchange of goods, services or experiences for currency, value and/or the like. The service is also, in some example embodiments, configured to offer merchant services such as promotion building (e.g., assisting merchants with selecting parameters for newly created promotions), promotion counseling (e.g., offering information to merchants to assist with using promotions as marketing), promotion analytics (e.g., offering information to merchants to provide data and analysis regarding the costs and return-on-investment associated with offering promotions), and the like.

As used herein, the terms “provider” and “merchant” may be used interchangeably and may include, but are not limited to, a business owner, consigner, shopkeeper, tradesperson, vendor, operator, entrepreneur, agent, dealer, organization or the like that is in the business of a providing a good, service or experience to a consumer, facilitating the provision of a good, service or experience to a consumer and/or otherwise operating in the stream of commerce. The “provider” or “merchant” need not actually market a product or service via the promotion and marketing service, as some merchants or providers may utilize the promotion and marketing service only for the purpose of gathering marketing information, demographic information, or the like.

As used herein, the term “consumer” should be understood to refer to a recipient of goods, services, promotions, media, or the like provided by the promotion and marketing service and/or a merchant. Consumers may include, without limitation, individuals, groups of individuals, corporations, other merchants, and the like.

As used herein, the term “promotion” may include, but is not limited to, any type of offered, presented or otherwise indicated reward, discount, coupon, credit, deal, incentive, discount, media or the like that is indicative of a promotional value or the like that upon purchase or acceptance results in the issuance of an instrument that may be used toward at least a portion of the purchase of particular goods, services and/or experiences defined by the promotion. Promotions may have different values in different contexts. For example, a promotion may have a first value associated with the cost paid by a consumer, known as an “accepted value.” When redeemed, the promotion may be used to purchase a “promotional value” representing the retail price of the goods. The promotion may also have a “residual value,” reflecting the remaining value of the promotion after expiration. Although consumers may be primarily focused on the accepted and promotional value of the promotion, a promotion may also have additional associated values. For example, a “cost value” may represent the cost to the merchant to offer the promotion via the promotion and marketing service, where the promotion and marketing service receives the cost value for each promotion sold to a consumer. The promotion may also include a “return on investment” value, representing a quantified expected return on investment to the merchant for each promotion sold.

For example, consider a promotion offered by the promotion and marketing service for a $50 meal promotion for $25 at a particular restaurant. In this example, $25 would be the accepted value charged to the consumer. The consumer would then be able to redeem the promotion at the restaurant for $50 applied toward their meal check. This $50 would be the promotional value of the promotion. If the consumer did not use the promotion before expiration, the consumer might be able to obtain a refund of $22.50, representing a 10% fee to recoup transaction costs for the merchant and/or promotion and marketing service. This $22.50 would be the residual value of the promotion. If the promotion and marketing service charged the merchant $3.00 to offer the promotion, the $3.00 fee would be the “cost value.” The “return on investment” value of the promotion might be dynamically calculated by the promotion and marketing service based on the expected repeat business generated by the marketing of the promotion, the particular location, the demographics of the consumer, and the like. For example, the return on investment value might be $10.00, reflecting the long term additional profit expected by the merchant as a result of bringing in a new customer through use of a promotion.

Promotions may be provided to consumers and redeemed via the use of an “instrument.” Instruments may represent and embody the terms of the promotion from which the instrument resulted. For example, instruments may include, but are not limited to, any type of physical token (e.g., magnetic strip cards or printed barcodes), virtual account balance (e.g., a promotion being associated with a particular user account on a merchant website), secret code (e.g., a character string that can be entered on a merchant website or point-of-sale), tender, electronic certificate, medium of exchange, voucher, or the like which may be used in a transaction for at least a portion of the purchase, acquisition, procurement, consumption or the like of goods, services and/or experiences as defined by the terms of the promotion.

In some examples, the instrument may take the form of tender that has a given value that is exchangeable for goods, services and/or experiences and/or a reduction in a purchase price of a particular good, service or experience. In some examples, the instrument may have multiple values, such as accepted value, a promotional value and/or a residual value. For example, using the aforementioned restaurant as the example provider, an electronic indication in a mobile application that shows $50 of value to be used as payment for a meal check at the restaurant. In some examples, the accepted value of the instrument is defined by the value exchanged for the instrument. In some examples, the promotional value is defined by the promotion from which the instrument resulted and is the value of the instrument beyond the accepted value. In some examples, the residual value is the value after redemption, the value after the expiry or other violation of a redemption parameter, the return or exchange value of the instrument and/or the like.

As used herein, the term “location data” refers to electronic information indicating a particular location. Location data may be associated with a consumer, a merchant, or any other entity capable of interaction with the promotion and marketing service. For example, in some embodiments location data is provided by a location services module of a consumer mobile device. In some embodiments, location data may be provided by a merchant indicating the location of consumers within their retail location. In some embodiments, location data may be provided by merchants to indicate the current location of the merchant (e.g., a food truck or delivery service). It should be appreciated that location data may be provided by various systems capable of determining location information, including, but not limited to, global positioning service receivers, indoor navigation systems, cellular tower triangulation techniques, video surveillance systems, or radio frequency identification (RFID) location systems.

It should be appreciated that the terms “mobile device” and “mobile terminal” refer to handheld computing devices such as cellular phones, personal digital assistants (PDAs), smartphones, and other portable devices that are capable of communicating via a wireless network. Such devices may include internal mechanisms for determining a location of the mobile device (e.g., global positioning system (GPS) receivers, cellular tower triangulation systems, or the like) or external mechanisms for determining the location of the mobile device (e.g., a barcode or other machine-readable code that can be scanned to detect the mobile device, a unique device identifier that is broadcast to a local network device or beacon to report that the device is in proximity, or the like). It should be understood that, while many of the embodiments described herein relate to mobile devices that include internal positioning mechanisms and which directly report the location of the mobile device, some embodiments of the instant invention also include mechanisms that do not rely on the mobile device itself to report the location, and as such these embodiments may be employed in any scenario where it is possible to identify the location of one or more mobile devices.

It should be appreciated that the term “hot zone” refers to a geo-fenced geographic area comprising a plurality of merchants identified as able to provide one or more products, services, and/or experiences as well as a pre-defined number of mobile devices and/or mobile terminals. Because hot zones require a pre-defined number of mobile devices with a particular geographic region, hot zones are ephemeral and as such, the use of hot zones is time-limited.

Technical Underpinnings and Implementation of Exemplary Embodiments

Merchants, including manufacturers, wholesalers, and retailers, have spent a tremendous amount of time, money, manpower, and other resources to determine the best way to market their products to consumers. Whether a given marketing effort is successful is often determined based on the return-on-investment offered to the merchant from increased awareness, sales, and the like of the merchant's goods and services in exchange for the resources spent on the marketing effort. In other words, optimal marketing techniques generally maximize the benefit to the merchant's bottom line while minimizing the cost spent on marketing. To this end, a merchant's marketing budget may be spent in a variety of different manners including advertising, offering of discounts, conducting market research, and various other known marketing techniques. The end goal of these activities is to ensure that products are presented to consumers in a manner that maximizes the likelihood that the consumers will purchase the product from the merchant that performed the marketing activities while minimizing the expense of the marketing effort.

The advent of electronic commerce has revolutionized the marketing process. While merchants would typically have to perform costly market research such as focus groups, surveys, and the like to obtain detailed information on consumer preferences and demographics, the digital age has provided a wealth of new consumer information that may be used to optimize the marketing and sales process. As a result, new technologies have been developed to gather, aggregate, analyze, and report information from a variety of electronic sources.

So-called “clickstream data” provides a robust set of information describing the various interactions consumers have with electronic marketing communications provided to them by merchants and others. Promotion and marketing services have been developed with sophisticated technology to receive and process this data for the benefit of both merchants and consumers. These services assist merchants with marketing their products to interested consumers, while reducing the chance that a consumer will be presented with marketing information in which the consumer has no interest. Some promotion and marketing services further leverage their access to a trove of electronic marketing information to assist merchants and consumers with other tasks, such as offering improved merchant point-of-sale systems, improved inventory and supply chain management, improved methods for delivering products and services, and the like.

Unlike conventional marketing techniques related to the use of paper or other physical media (e.g., coupons clipped from a weekly newspaper), promotion and marketing services offer a wealth of additional electronic solutions to improve the experience for consumers and merchants. The ability to closely monitor user impressions provides the ability for the promotion and marketing service to gather data related to the time, place, and manner in which the consumer engaged with the impression (e.g., viewed, clicked, moused-over) and obtained and redeemed the promotion. The promotion and marketing service may use this information to determine which products and services are most relevant to the consumer's interest, and to provide marketing materials related to said products and services to the consumer, thus improving the quality of the electronic marketing communications received by the consumer. Merchants may be provided with the ability to dynamically monitor and adjust the parameters of promotions offered by the promotion and marketing service, ensuring that the merchant receives a positive return on their investment. For example, the merchant can closely monitor the type, discount level, and quantity sold of a particular promotion on the fly, while with traditional printed coupons the merchant would not be able to make any changes to the promotion after the coupon has gone to print. Each of these advancements in digital market and promotion distribution involve problems unique to the digital environment not before seen in traditional print or television broadcast marketing.

However, these promotion and marketing services are not without problems. Although electronic marketing information provides a wealth of information, the inventors have determined that existing techniques may not always leverage this information in an efficient or accurate manner. Technology continues to rapidly advance in the field of analytics and the processing of this information, offering improved data gathering and analysis techniques, resulting in more relevant and accurate results provided in a more efficient manner. Electronic marketing services continue to evolve and provide improved methods for engaging consumers and spreading awareness of products offered by promotion and marketing services.

In many cases, the inventors have determined that these services are constrained by technological obstacles unique to the electronic nature of the services provided, such as constraints on data storage, machine communication and processor resources. The inventors have identified that the wealth of electronic marketing information available to these services and the robust nature of electronic marketing communications techniques present new challenges never contemplated in the world of paper coupons and physical marketing techniques. The inventors have further determined that even technological methods that leverage computers for statistical analysis and consumer behavior modeling (e.g., television rating systems) fail to address problems associated with providing relevant, high quality electronic marketing communications (e.g., impressions) to consumers in a manner that maximizes accuracy, minimizes error, is user friendly and provides for efficient allocation of resources. Embodiments of the present invention as described herein serve to correct these errors and offer improved resource utilization, thus providing improvements to electronic marketing services that address problems arising out of the electronic nature of those services.

As market penetration of smartphones and other such mobile devices has increased, it has become increasingly common for consumers to have access to devices that provide the ability to detect and report the consumer's location. By using certain applications that determine the consumer's location and electing to provide such location data to external users, consumers may receive a variety of benefits tailored to their particular location. For example, a variety of applications exist that leverage the ability to know the location of the consumer and provide specially-tailored coupons, discounts, notifications, and the like. However, systems that leverage the ability to target location-based electronic marketing communications and other notifications are still quite rudimentary, relying on hard-coded detection of proximity to particular points of interest. For example, a given system may detect the presence of a consumer near a particular store, and offer a coupon for that store via a notification sent to the user's mobile device. However, such systems are incapable of detecting ad hoc or temporary events (e.g., parades, fairs), or disambiguating between events at venues that may host a variety of types of events (e.g., a football stadium that hosts both football games and concerts, or a concert hall that hosts both standup comedians and musicians). Although systems have been developed that allow administrators to “hard code” such events as occurring at a particular time or place, these systems require manual entry of event types, associated locations, and associated actions to be taken related to that event.

The inventors have recognized that, by leveraging access to a set of location information provided by a plurality of mobile devices, it is possible to implement systems and methods that programmatically detect when consumers are congregating in a particular area. In response to detecting a congregation of consumers in an area, the systems and methods programmatically identify an event as occurring. These systems and methods may be further operable to identify an event venue and type using other data sources, such as event catalogues, venue websites, or the like. Once an event is detected, embodiments may establish a geo-fence about the event to identify other consumers attending the event, and take appropriate actions based on the presence of the consumers at the event.

Upon implementing a system for detection of events as described herein, the inventors further have realized that retrieving a multitude of sets of location information from a large number of mobile terminals requires a substantial amount of processing resources, since identifying consumers congregating in an arbitrary location involves comparing received locations with other received locations, presenting certain issues regarding scaling as the number of mobile terminals providing location data increases. The inventors have developed novel algorithms and processing techniques for addressing these issues, including implementation of a queue structure as part of the event detection process, thereby providing an efficient mechanism for comparing locations to one another to identify scenarios where consumers appear to be congregating.

The inventors have additionally realized that it is possible to leverage access to certain wireless carrier services to improve the process by which events are detected. For example, some wireless carriers include the ability for users to allow certain application developers to request location or other information from their mobile devices even when those mobile devices are not executing an application associated with the application developer. As a particular example, a consumer may select an option that allows the application developer to, via the wireless carrier, “ping” the consumer's mobile device to obtain location information. While such information would typically be provided directly from the mobile device to the application developer via execution of the application on the mobile device, the consumer may prefer to not allow that application to access location information when executing as a background process in order to reduce battery consumption. Embodiments of the present invention may thus interface with wireless carrier systems to request location information from such consumers, thereby providing the advantage of reduced battery consumption of the mobile terminal (e.g., due to the fact that the local application is not actively providing location data), while still providing the benefits of targeted notifications based on detection that the user is near an event.

Additionally, by storing information related to identified hot zones, the inventors have recognized that it is possible to programmatically predict future hot zones. For example, the inventors have recognized that by monitoring particular geographic regions or merchants, the hot zones associated with particular geographic regions or merchants, the dates and times of these detected events may be used to determine the frequency of such occurrences. For example, a football stadium may have games most frequently on Sundays during the fall and winter. By monitoring when these hot zones occur, the system may be able to predict future hot zones.

### System Architecture

Methods, apparatuses, and computer program products of the present invention may be embodied by any of a variety of devices. For example, the method, apparatus, and computer program product of an example embodiment may be embodied by a networked device, such as a server or other network entity, configured to communicate with one or more devices, such as one or more client devices. Additionally or alternatively, the computing device may include fixed computing devices, such as a personal computer or a computer workstation. Still further, example embodiments may be embodied by any of a variety of mobile terminals, such as a portable digital assistant (PDA), mobile telephone, smartphone, laptop computer, tablet computer, or any combination of the aforementioned devices.

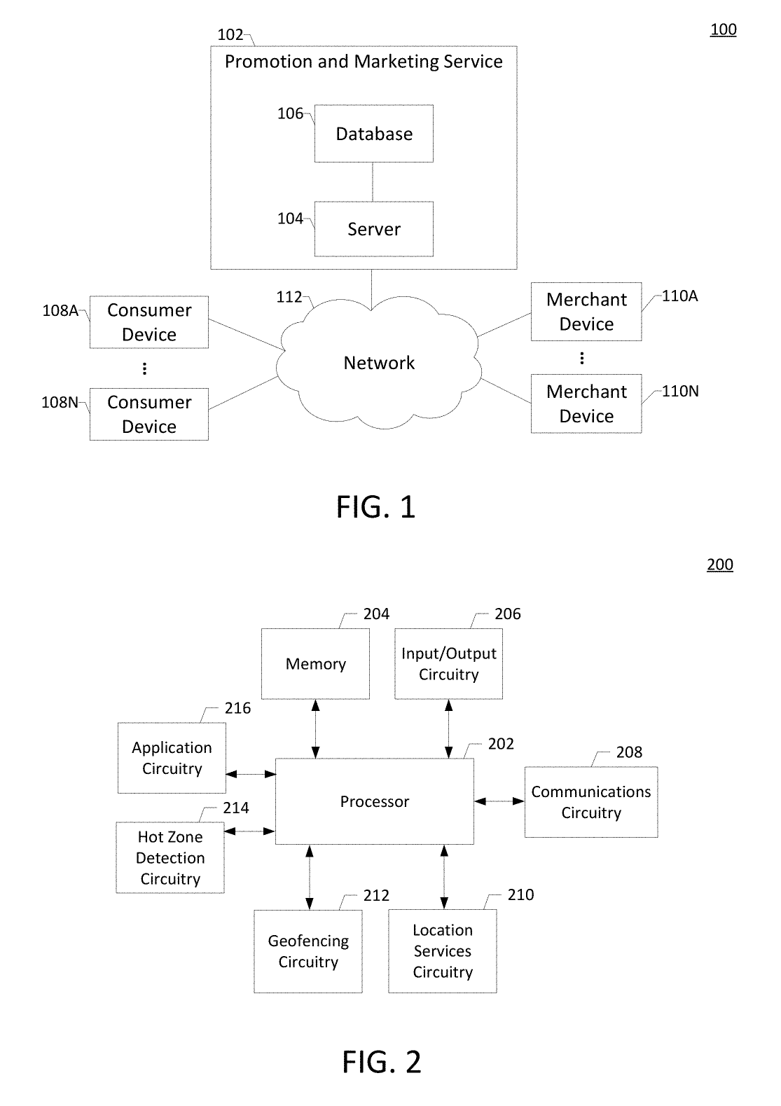

In this regard, FIG. 1 discloses an example computing system within which embodiments of the present invention may operate. Merchants may access a promotion and marketing service 102 via a network 112 (e.g., the Internet, or the like) using computer devices 108A through 108N and 110A through 110N, respectively (e.g., one or more consumer devices 108A-108N or one or more merchant devices 110A-110N). The promotion and marketing service 102 may function to detect events based on consumer location information as described herein and below. Moreover, the promotion and marketing service 102 may comprise a server 104 in communication with a database 106.

The server 104 may be embodied as a computer or computers as known in the art. The server 104 may provide for receiving of electronic data from various sources, including but not necessarily limited to the consumer devices 108A-108N and the merchant devices 110A-110N. For example, the server 104 may be operable to receive and process clickstream data provided by the consumer devices 108 and/or the merchant devices 110. The server 104 may also facilitate e-commerce transactions based on transaction data provided by the consumer devices 108 and/or the merchant devices 110. The server 104 may facilitate the generation and providing of various electronic marketing communications and marketing materials based on the received electronic marketing information.

The database 106 may be embodied as a data storage device such as a Network Attached Storage (NAS) device or devices, or as a separate database server or servers. The database 106 includes information accessed and stored by the server 104 to facilitate the operations of the promotion and marketing service 102. For example, the database 106 may include, without limitation, user account credentials for system administrators, merchants, and consumers, data indicating the products and promotions offered by the promotion and marketing service, electronic marketing information, analytics, reports, financial data, and/or the like.

The consumer devices 108A-108N may be any computing device as known in the art and operated by a consumer. Electronic data received by the server 104 from the consumer devices 108A-108N may be provided in various forms and via various methods. For example, the consumer devices 108A-108N may include desktop computers, laptop computers, smartphones, netbooks, tablet computers, wearables, and the like. The information may be provided through various sources on these consumer devices.

In embodiments where a consumer device 108 is a mobile device, such as a smart phone or tablet, the consumer device 108 may execute an “app” to interact with the promotion and marketing service 102. Such apps are typically designed to execute on mobile devices, such as tablets or smartphones. For example, an app may be provided that executes on mobile device operating systems such as Apple Inc.'s iOS®, Google Inc.'s Android®, or Microsoft Inc.'s Windows 8® and Windows 10®. These platforms typically provide frameworks that allow apps to communicate with one another and with particular hardware and software components of mobile devices. For example, the mobile operating systems named above each provide frameworks for interacting with location services circuitry, wired and wireless network interfaces, user contacts, and other applications in a manner that allows for improved interactions between apps while also preserving the privacy and security of consumers. In some embodiments, a mobile operating system may also provide for improved communication interfaces for interacting with external devices (e.g., home automation systems, indoor navigation systems, and the like). Communication with hardware and software modules executing outside of the app is typically provided via application programming interfaces (APIs) provided by the mobile device operating system.

The promotion and marketing service 102 may leverage the application framework offered by the mobile operating system to allow consumers to designate which information is provided to the app and which may then be provided to the promotion and marketing service 102. In some embodiments, consumers may “opt in” to provide particular data to the promotion and marketing service 102 in exchange for a benefit, such as improved relevancy of marketing communications offered to the user. In some embodiments, the consumer may be provided with privacy information and other terms and conditions related to the information provided to the promotion and marketing service 102 during installation or use of the app. Once the consumer provides access to a particular feature of the mobile device, information derived from that feature may be provided to the promotion and marketing service 102 to improve the quality of the consumer's interactions with the promotion and marketing service.

For example, the consumer may indicate that they wish to provide location information to the app from location services circuitry included in their mobile device. Providing this information to the promotion and marketing service 102 may enable the promotion and marketing service 102 to offer promotions to the consumer that are relevant to the particular location of the consumer (e.g., by providing promotions for merchants proximate to the consumer's current location). It should be appreciated that the various mobile device operating systems may provide the ability to regulate the information provided to the app associated with the promotion and marketing service 102. For example, the consumer may decide at a later point to disable the ability of the app to access the location services circuitry, thus limiting the access of the consumer's location information to the promotion and marketing service 102.

As noted above, some wireless carriers may also provide consumers with the ability to “opt in” to allowing certain application developers to request mobile device location information directly from the wireless carrier (e.g., a location derived from which cellular tower or towers with which the mobile device is in communication) without the need to directly contact the mobile terminal. Such embodiments may advantageously reduce the amount of mobile device battery life required to receive location-based notifications while still providing benefits derived from the ability to determine when the consumer is at a particular event as described herein.

Various other types of information may also be provided in conjunction with an app executing on the consumer's mobile device. For example, if the mobile device includes a social networking feature, the consumer may enable the app to provide updates to the consumer's social network to notify friends of a particularly interesting promotion or to indicate that the consumer has been detected at a particular event. It should be appreciated that the use of mobile technology and associated app frameworks may provide for particularly unique and beneficial uses of the promotion and marketing service through leveraging the functionality offered by the various mobile operating systems.

Additionally or alternatively, the consumer device 108 may interact through the promotion and marketing service 102 via a web browser. As yet another example, the consumer device 108 may include various hardware or firmware designed to interface with the promotion and marketing service 102 (e.g., where the consumer device 108 is a purpose-built device offered for the primary purpose of communicating with the promotion and marketing service 102, such as a store kiosk).

The merchant devices 110A-110N may be any computing device as known in the art and operated by a merchant. For example, the merchant devices 110A-110N may include a merchant point-of-sale, a merchant local marketing device, a merchant e-commerce server, a merchant inventory system, or a computing device accessing a web site designed to provide merchant access (e.g., by accessing a web page via a browser using a set of merchant account credentials). The merchant devices 110A-110N may also be mobile devices as described above with respect to the consumer devices 108A-108N.

Electronic data received by the promotion and marketing service 102 from the merchant devices 110A-110N may also be provided in various forms and via various methods. For example, the merchant devices 110A-110N may provide real-time transaction and/or inventory information as purchases are made from the merchant. In other embodiments, the merchant devices 110A-110N may be employed to provide information to the promotion and marketing service 102 to enable the promotion and marketing service 102 to generate promotions or other marketing information to be provided to consumers.

### Example Apparatuses for Implementing Embodiments of the Present Invention

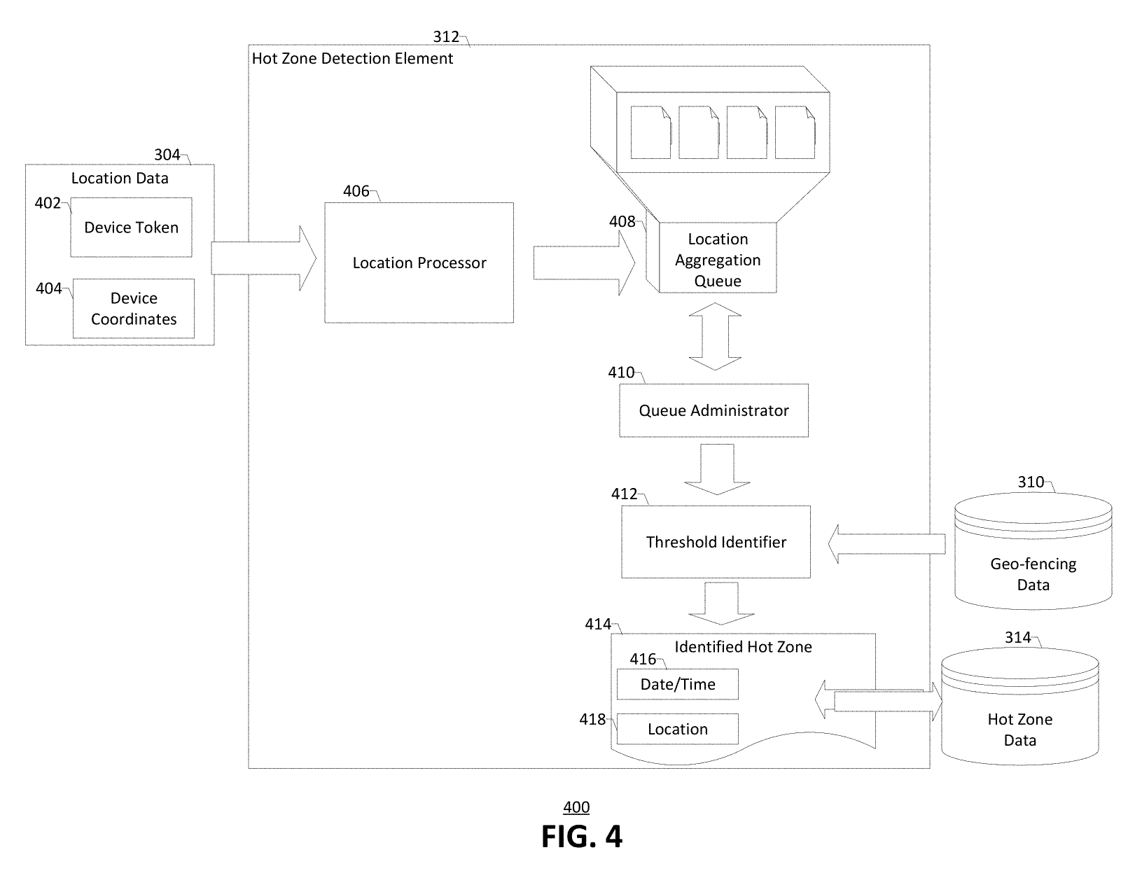

The server 104 may be embodied by one or more computing systems, such as apparatus 200 shown in FIG. 2. As illustrated in FIG. 2, the apparatus 200 may include a processor 202, a memory 204, input/output circuitry 206, communications circuitry 208, location services circuitry 210, event detection circuitry 212, geo-fencing circuitry 214, and application circuitry 216. The apparatus 200 may be configured to execute the operations described above with respect to FIG. 1 and below with respect to FIGS. 4-10. Although these components 202-216 are described with respect to functional limitations, it should be understood that the particular implementations necessarily include the use of particular hardware. It should also be understood that certain of these components 202-216 may include similar or common hardware. For example, two sets of circuitry may both leverage use of the same processor, network interface, storage medium, or the like to perform their associated functions, such that duplicate hardware is not required for each set of circuitry. The use of the term “circuitry” as used herein with respect to components of the apparatus should therefore be understood to include particular hardware configured to perform the functions associated with the particular circuitry as described herein.

The term “circuitry” should be understood broadly to include hardware and, in some embodiments, software for configuring the hardware. For example, in some embodiments, “circuitry” may include processing circuitry, storage media, network interfaces, input/output devices, and the like. In some embodiments, other elements of the apparatus 200 may provide or supplement the functionality of particular circuitry. For example, the processor 202 may provide processing functionality, the memory 204 may provide storage functionality, the communications circuitry 208 may provide network interface functionality, and the like.

In some embodiments, the processor 202 (and/or co-processor or any other processing circuitry assisting or otherwise associated with the processor) may be in communication with the memory 204 via a bus for passing information among components of the apparatus. The memory 204 may be non-transitory and may include, for example, one or more volatile and/or non-volatile memories. In other words, for example, the memory may be an electronic storage device (e.g., a computer readable storage medium). The memory 204 may be configured to store information, data, content, applications, instructions, or the like, for enabling the apparatus to carry out various functions in accordance with example embodiments of the present invention.

The processor 202 may be embodied in a number of different ways and may, for example, include one or more processing devices configured to perform independently. Additionally or alternatively, the processor may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In an example embodiment, the processor 202 may be configured to execute instructions stored in the memory 204 or otherwise accessible to the processor. Alternatively or additionally, the processor may be configured to execute hard-coded functionality. As such, whether configured by hardware or software methods, or by a combination thereof, the processor may represent an entity (e.g., physically embodied in circuitry) capable of performing operations according to an embodiment of the present invention while configured accordingly. Alternatively, as another example, when the processor is embodied as an executor of software instructions, the instructions may specifically configure the processor to perform the algorithms and/or operations described herein when the instructions are executed.

In some embodiments, the apparatus 200 may include input/output circuitry 206 that may, in turn, be in communication with processor 202 to provide output to the user and, in some embodiments, to receive an indication of a user input. The input/output circuitry 206 may comprise a user interface and may include a display and may comprise a web user interface, a mobile application, a client device, a kiosk, or the like. In some embodiments, the input/output circuitry 206 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 204, and/or the like).

The communications circuitry 208 may be any means such as a device or circuitry embodied in either hardware or a combination of hardware and software that is configured to receive and/or transmit data from/to a network and/or any other device, circuitry, or module in communication with the apparatus 200. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally or alternatively, the communication interface may include the circuitry for interacting with the antenna(s) to cause transmission of signals via the antenna(s) or to handle receipt of signals received via the antenna(s).

The location services circuitry 210 includes hardware configured to receive or determine a location of a plurality of mobile devices. The location services circuitry 210 may include an interface for communicating with the mobile devices over a network. Such an interface may be provided by the communications circuitry 208. The location services circuitry 210 may include a network interface that receives location information reported by the mobile device via an application and location services module located on the mobile device itself. Additionally or alternatively, the location services circuitry 210 may include an interface to a wireless carrier or other third party system capable of providing location information for one or more mobile terminals. Additionally or alternatively, the location services circuitry 210 may also include hardware configured to determine the location of the one or more mobile terminals based on received data. For example, the location services circuitry 210 may include hardware configured to determine the location of the mobile terminal based on data indicating which wireless stations (e.g., wireless access points or cellular towers) with which the mobile terminal is in communication. Upon receiving a location or locations of a mobile terminal or terminals, the location services circuitry 210 may notify the event detection circuitry 212 of the location. This notification may occur via an application programming interface (API), shared memory, bus, or the like. In some embodiments, the location services circuitry 210 may be implemented as a component of the event detection circuitry 212, and the location information may be communicated internally to the consolidated module. The location services circuitry 210 may include a separate processor to receive and/or determine the location of mobile terminals. The location services circuitry 210 is therefore implemented using hardware components of the apparatus configured by either hardware or software for implementing these planned functions.

The geo-fencing circuitry 212 includes hardware configured to authorize the transmission of electronic marketing communications to consumers. To this end, the geo-fencing circuitry 212 may identify a geographic area or range of coordinate values that correspond to a geographic region comprising a plurality, or in some embodiments, pre-defined number of merchant devices, such that Point-of-Sale type devices, mobile devices used by merchants, or the like that are detected within the geographic area or range of coordinate values. The location services circuitry 210 may provide the geo-fencing circuitry 212 with locations of mobile terminals in order to determine if those mobile terminals are within the geo-fence. Upon detection of a mobile terminal within the geo-fence, the geo-fencing circuitry 212 may notify the application circuitry 216, so that the application circuitry 216 may take appropriate action. The geo-fencing circuitry 212 includes processing circuitry, such as the processor 202, configured to perform these functions. The geo-fencing circuitry 212 also includes data storage, such as the memory 204, to store and access relevant data including storage of events, event types, corresponding geo-fences, and the like. The geo-fencing circuitry 212 is therefore implemented using hardware components of the apparatus configured by either hardware or software for implementing these planned functions.

The hot zone generation circuitry 214 includes hardware configured to identify geographic areas and/or locations at which a number of mobile terminals are located, and where, for example, a congregation of mobile devices occurs within an area located within a geo-fenced region, for example, comprising a plurality of merchant devices, a multitude of service providers, or the like. The hot zone generation circuitry 214 may further be configured to identify a particular merchant, service provider, and/or venue associated with a hot zone, and/or a hot zone type. To perform these determinations, the hot zone generation circuitry 214 implements one or more process threads and algorithms to receive mobile terminal locations, to determine if those locations are associated with any recently received locations, to filter received locations based on a density of consumers and/or a velocity of those consumers, to identify locations where more than a threshold number of consumers are detected within a geographic region identified as comprising a plurality of merchant devices.

It should also be appreciated that, in some embodiments, the hot zone generation circuitry 214 may include a separate processor or the like to generate one or more electronic marketing communications. The hot zone generation circuitry 214 may also include a storage mechanism, such as the memory 204, for storing received mobile terminal locations, storing values related to counting of mobile terminal locations about a particular location, storing identified hot zones, and the like. The hot zone generation circuitry 214 is therefore implemented using hardware components of the apparatus configured by either hardware or software for implementing these planned functions.

The application circuitry 216 includes hardware configured to take particular actions upon detection of a mobile terminal at a location associated with a hot zone defined by the hot zone generation circuitry 212. When the system determines that a mobile device has been detected within a hot zone, the application circuitry 216 may be notified of the mobile terminal and the particular hot zone within which the mobile terminal was detected. The application circuitry 216 may implement various functions based on the detection of the mobile terminal within the hot zone. For example, in some embodiments, the application circuitry 216 may generate a notification or other electronic marketing communication to the mobile terminal upon being notified that the mobile terminal is located within the hot zone. This electronic marketing communication may include a promotion associated with a particular merchant located within the hot zone (e.g., a discount at a concession stand), a promotion associated with a hot zone type (e.g., a discount associated with an album by a musician performing at a merchant within the hot zone), a promotion associated with a venue within the hot zone (e.g., season passes for a symphony), a promotion associated with a nearby merchant (e.g., make reservations at this local restaurant for after the game) or the like.

The application circuitry 216 may include processing circuitry, such as the processor 202, configured to perform these functions. It should also be appreciated that, in some embodiments, the application circuitry 216 may include a separate processor, networking circuitry, protocols, and messaging techniques to implement a variety of functions relating to using dynamically detected events, including but not limited to functions of a promotion and marketing service, an email or text message notification system, or the like. The application circuitry 216 is therefore implemented using hardware components of the apparatus configured by either hardware or software for implementing these planned functions.

As will be appreciated, any such computer program instructions and/or other type of code may be loaded onto a computer, processor or other programmable apparatus's circuitry to produce a machine, such that the computer, processor other programmable circuitry that execute the code on the machine create the means for implementing various functions, including those described herein.

It is also noted that all or some of the information presented by example displays described herein can be based on data that is received, generated and/or maintained by one or more components of apparatus 200. In some embodiments, one or more external systems (such as a remote cloud computing and/or data storage system) may also be leveraged to provide at least some of the functionality discussed herein.

As described above and as will be appreciated based on this disclosure, embodiments of the present invention may be configured as methods, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Any suitable computer-readable storage medium may be utilized including non-transitory hard disks, CD-ROMs, flash memory, optical storage devices, or magnetic storage devices.

### Example Electronic Marketing Information Service Data Flow

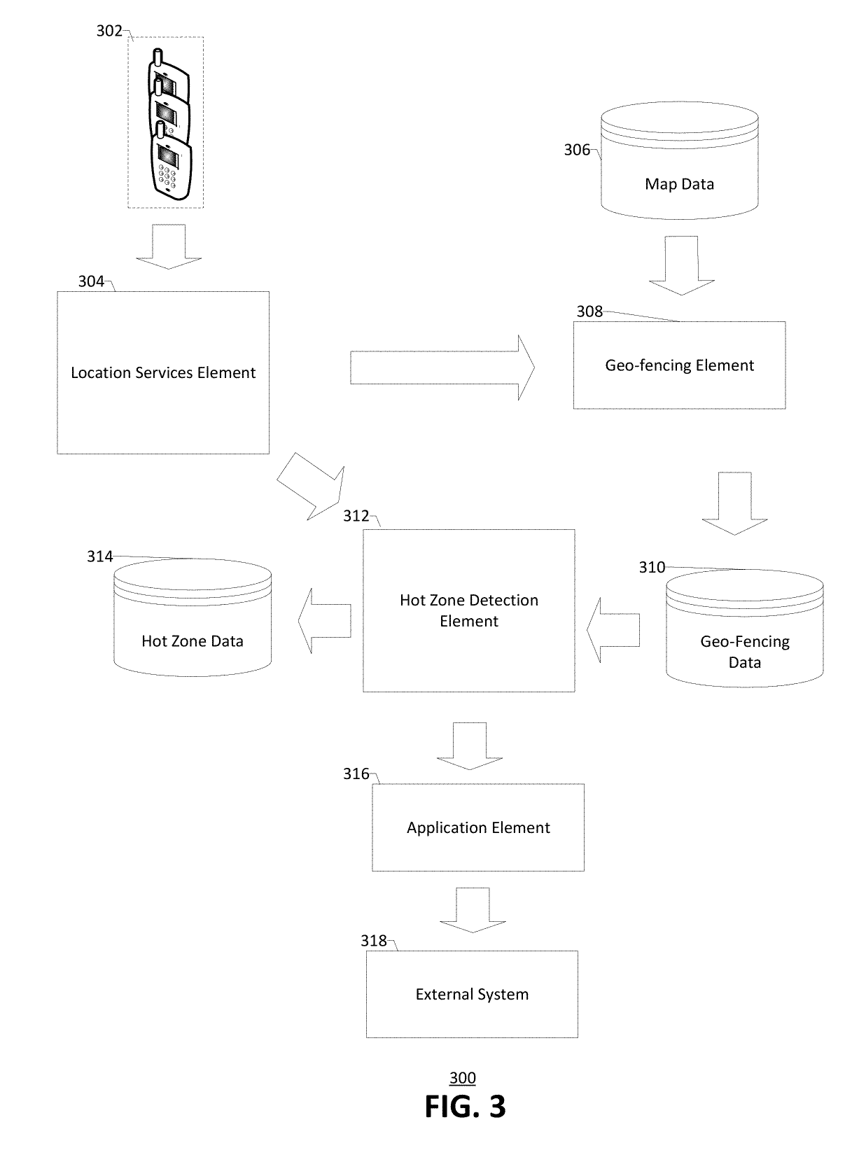

FIG. 3 depicts an exemplary data flow among components of a system implementing a mechanism enabling the identification of one or more hot zones in accordance with some exemplary embodiments of the present invention. The data flow 300 illustrates incoming and outgoing data through a system operable to receive location information and to determine the occurrence of hot zones based on detection of congregating users in a geographic region identified as comprising a plurality of merchants. The process begins with the receipt of location information by a location services element 304. This location information is received, directly or indirectly from one or more mobile devices 302. For example, the mobile devices 302 may report location information directly to the location services element 304 via an application executing on the mobile device 302, or the location services element 304 may obtain the location information from another service, such as a wireless carrier.

The location services element 304 provides information about the location of each device 302 to a hot zone detection element 312. This location information may include coordinates of the particular device 302 and a token or other identifier associated with the device 302, among other information. The location services element 304 may be implemented, for example, by the location services circuitry 210 described above with respect to FIG. 2. In some embodiments, this other information may include, for example, a device velocity, a particular nearby point of interest or venue, or the like.

The geo-fencing element 308 is operable to receive or otherwise access location information associated with merchants and/or map data 306 and identify those merchants proximate to one or more other merchants, and generate geo-fenced geographic areas comprising one or more merchants. The geo-fencing element 308 may then be operable to provide information indicative of the geo-fenced geographic areas to the hot zone detection element 312.

The hot zone detection element 312 is operable to detect concentrations and congregations of mobile devices within particular areas, and to determine whether the number of the plurality of mobile devices that are located within an area, the area located within at least one of the geo-fenced geographic regions comprising two or more merchant devices, meets a predefined threshold number of mobile devices required in a particular area for the particular area to be considered a hot zone. The hot zone detection element 312 may be implemented, for example, by the hot zone detection circuitry 214 described above with respect to FIG. 2.

The geo-fencing data 310 may include information regarding locations, hyper-locations, neighborhoods, or the like and as well as the merchants that reside therein. The geo-fencing data 310 may also include merchant types, schedules, and the like. For example, the geo-fencing data 608 may include musician tour data, movie release schedules, concert hall schedules, sports schedules, or the like. The geo-fencing data may also include more general information, such as a set of types of merchants that may occur at a particular venue or venue type (e.g., stadiums may have football games, soccer games, and concerts, while concert halls may have standup comedy performances, play productions, symphonies, musician performances, and the like), or the like. This geo-fencing data may be manually curated (e.g., entered into the system by one or more users), or programmatically generated through the use of textual analysis of network content (e.g., scraping a venue website to identify event schedules). The geo-fencing data 310 may be used by the hot zone detection element 312 to map a detected congregation of mobile devices to a particular geographic region.

The geo-fencing data 310 may also include information relating to particular points of interest, such as location coordinates (e.g., latitude and longitude), a name of the point of interest, a type of the point of interest (e.g., store, park, stadium, etc.), a crowd capacity of the point of interest, or the like. This geo-fencing data 310 may be used by the hot zone detection element 312 to identify likely points of interest or venues for association with detected congregations of mobile devices. The geo-fencing data 610 may also be used to map a point of interest to a particular merchant schedule.

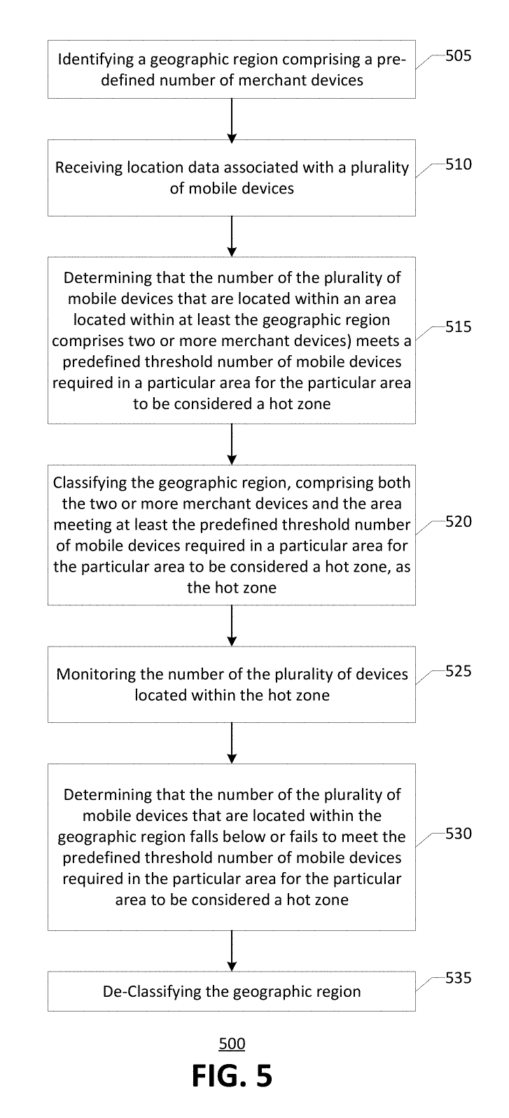

The output of the hot zone detection element 312 may be a set of one or more detected hot zones 314. Examples of processes and algorithms for generation such detected events, and the content thereof, are described further below with respect to FIGS. 5-7.

The detected hot zone 314 may be transmitted to an application element 316 and/or to an external system 318. The application element 316 and/or the external system 318 may take a variety of different actions upon such a detection. For example, in some embodiments the application element 316 and/or the external system 318 may trigger a notification to the mobile device detected within a hot zone, such as generation of an electronic marketing communication referencing a product or service associated with a merchant located within the hot zone. As another example, the application element 316 and/or the external system 318 may identify, for example, other merchants located within the hot zone for inclusion in the system. In some embodiments, the application element 316 and/or the external system 318 may maintain one or more user and/merchant profiles, such that the presence of a particular mobile device within a particular hot zone triggers an update to a user profile associated with that device, indicating that the user traveled within the hot zone. Such data may be employed for use in future marketing processes.

FIG. 4 illustrates an example of a data flow 400 for detecting a hot zone using a hot zone detection element 312 as described above with respect to FIGS. 2 and 3. The data flow 400 illustrates the various data inputs to the hot zone detection element 312, and the process by which those inputs are used to output an identified hot zone 414. The hot zone detection element 312 may be the hot zone detection element 312 as described above with respect to FIG. 3, implemented by hot zone detection circuitry 210 as described above with respect to FIG. 2.

The hot zone detection element 312 receives location data 402. As described above, the location data 402 may be received via a location services element. The location data 304 may include a device token 402 and a set of device coordinates 404, among other information. The device token 402 is an identifier associated with a particular device so as to identify the device that is associated with the location. The device token 404 may be an identifier that associates the particular device with a particular consumer or user login credentials for an account maintained by a promotion and marketing service. The device coordinates 404 are location coordinates that define the location of the device. This location may be provided in any of a variety of location formats, including but not limited to a latitude and longitude, a street address, or the like. The location data is received by a location processor 406 of the hot zone detection element 312.

The location processor 406 processes the received location data 304 to add the location data to a location aggregation queue 408. The location aggregation queue 408 includes a data structure that stores recently received device locations for use in identification of congregating users. In order to improve processing efficiency, the location aggregation queue 408 may drop received locations from time to time. For example, locations may age off the queue (e.g., removed after 15 minutes, 30 minutes, or one hour), they may be removed after the queue reaches a certain size (e.g., the queue may store the most recently received 1,000, 10,000, or 1,000,000 locations), or the like.

A queue administrator 410 may manage the data stored within the location aggregation queue 408. The queue administrator 410 may function to identify the number of locations within the queue that are at the same location or within a threshold distance of one another. For example, the queue administrator 410 may, when a new location is added to the location aggregation queue 408, review the contents of the location aggregation queue 408 to count the number of locations that are within a particular proximity to the newly added location. In the event that at least a threshold number of locations stored in the location aggregation queue 408 are proximate to the newly received location, then that location may be flagged. In other embodiments, the queue administrator 410 may review the locations stored within the location aggregation queue 408 at periodic intervals (e.g., every second, every minute, every 15 minutes, every hour, or the like) for location detection purposes, rather than when new locations are added.

The queue administrator 410 may also serve to filter and otherwise edit the locations stored within the location aggregation queue 408. For example, in some embodiments the queue administrator 410 may identify locations associated with the same device token 402, and use changes in those locations over time to determine a velocity of the associated device. The queue administrator 410 may use such velocities and other characteristics of locations stored in the location aggregation queue 408 to improve the process of location detection. For example, the queue administrator 410 may ensure that locations counted to possibly exceed the threshold for flagging an event each have less than a particular predefined velocity. Such pruning of results may reduce “false positive” event detections in scenarios where large users are present at a location, but just passing through (e.g., traffic on a highway). Such velocity metrics may also be employed to predict future locations of each particular mobile device in an effort to identify patterns of movement toward or away from a particular location. Embodiments may therefore count not only mobile devices within a proximity to a particular location or one another, but also devices that are moving in a direction to be within that proximate location at a particular time period in the near future (e.g., by counting devices likely to be proximate to an area within 10 minutes based on the calculated velocity).

The queue administrator 410 may notify the threshold identifier 412 of circumstances where greater than a threshold number of devices are detected within proximity to one another. In response, the threshold identifier 412 may review the location associated with the congregating devices and determine whether a geographic area comprising a plurality of merchant devices is co-located. In some embodiments, identification of the a geographic region in which a plurality of merchant devices are located may be performed through counting the number of devices and verifying that those devices are staying within that particular area for at least a threshold period of time (e.g., 5 minutes, 10 minutes, 20 minutes). Such embodiments may be well-suited for identifying areas that are not necessarily publicly scheduled or which are not necessarily associated with particular venues (e.g., flash mobs, protests, impromptu rallies, or the like).

In other embodiments, the threshold identifier 412 may utilize other data sources to determine whether a geographic region in which a plurality of merchants reside is nearby. For example, the threshold identifier 412 may identify nearby points of interest to the location using point of interest data 310. The threshold identifier 412 may determine whether one or more points of interest that may support, for example, a hot zone (e.g., concert venue, park, stadium, or other point of interest) are proximate to the identified location. In some embodiments, whether a hot zone exists may be determined based on the nearby events. For example, geographic regions in which a number of independent merchants may be associated may require a much lower threshold of congregating users to identify a hot zone, for example, compared to geographic regions comprising a large strip mall comprised of big box stores.

The threshold identifier 412 may also leverage access to geo-fencing data 310. As noted above, geo-fencing data 310 may include information related to events scheduled at particular venues, types of events that occur at particular venues, user activity related to certain events or event types (e.g., tailgating consumers may be more common at football games than at concerts, so the presence of consumers arriving early at an event parking lot is likely to be more indicative of a football game than a concert), or the like.

The threshold identifier 412 may use the geo-fencing data 310 to attempt to determine the particular location, schedule, and type of merchants associated with the congregation of users identified by the queue administrator 410. The identified hot zone 414 may include a particular date and time 416, a type, and the location 418. It should be appreciated that a hot zone may also include various other metadata or associated information, and that certain aspects of the event, such as the type may include various levels of detail. For example, a hot zone may be labeled as a “concert”, a “rock concert” or a “Foo Fighters concert” in increasing levels of granularity. A given hot zone may include identifiers for one or more of these characteristics. The location of the hot zone 418 may include a particular venue, or particular coordinates. This location may be used to establish a geo-fence about the identified location to identify other mobile devices entering the hot zone.

### Exemplary Processes for Implementing an Event Detection System

FIGS. 5-7 illustrate flow diagrams depicting processes for implementing the systems described above with respect to FIGS. 1-4 to detect hot zone based on received location information.

FIG. 5 illustrates a flow diagram depicting an example of a process 500 for identifying a geographic region as a hot zone, monitoring the criteria making it so, and identifying when the geographic region is no longer a hot zone in accordance with some exemplary embodiments of the present invention. The process 500 illustrates how location data can be received from a plurality of mobile devices and used to dynamically identify hot zones based on congregations of those mobile devices within geographic regions comprising a plurality of merchant devices. The process 500 further includes the processes for how and when hot zones are de-classified. The process 500 may be performed by elements of an apparatus 200, such as location services circuitry 210 acting in concert with geo-fencing circuitry 212, hot zone detection circuitry 214, and application circuitry 216 as described above with respect to FIG. 2.

As shown in block 505 of FIG. 5, an apparatus, such as apparatus 200, may be configured for identifying a geographic region comprising a pre-defined number of merchant devices. Before, after, or concurrently, as shown in block 510 of FIG. 5, an apparatus, such as apparatus 200, may be configured for receiving location data associated with a plurality of mobile devices. As described above, the device locations may be received via a location services element, which receives the device locations directly or indirectly from mobile devices. In some embodiments, each of the mobile devices and/or merchant devices may report location information to a remote server at certain intervals, or on demand. That is, while it is generally understood that mobile devices in use by consumers move frequently, many merchants may also be capable and of changing locations. For example, food trucks, merchandise tents, or the like often locate near particular merchants (e.g., venues, concert halls, stadiums, or the like) at particular times for particular time periods.

Mobile devices may report a location every 5 minutes, every 10 minutes, or every hour. In some embodiments, location reporting may be based upon execution of a particular application, such as a mobile application provided by an application developer. This application may access location information stored on the mobile device or utilize location services circuitry (e.g., a GPS receiver) on the mobile device to determine a location and report that location to a remote server associated with the application. The ability of the application to perform this functionality may be as a result of a user of the mobile device “opting in” to enable access to the location information by the mobile device. The movement vector for each of the mobile devices may be reported to a server by the mobile device, or the server may determine the movement vector based in a change in location over multiple location readings.

As shown in block 515 of FIG. 5, an apparatus, such as apparatus 200, may be configured for determining that the number of the plurality of mobile devices that are located within an area meets a predefined threshold number of mobile devices required in a particular area for the particular area to be considered hot. In some embodiments, hot is an objective determination based on pre-defined criteria. For example, a particular region may determine the particular number of mobile devices included within for the particular regions to be considered hot based on historical data, the number of merchants contained therein, the type of merchants contained therein, the time (e.g., the day of the week, the time of the day, the season, the time of year), the weather, or the like. In some embodiments, the area (i.e. determined to comprise the mobile devices) may be located within at least the geographic region comprising two or more merchant devices. In some embodiments, the area and the particular region overlap completely while in other embodiments, the area is contained within the particular region.

In those embodiments, in which it is determined that an area meets a predefined threshold number of mobile devices required in a particular area for the particular area to be considered hot, the area and/or the particular region may be considered hot. As such, as shown in block 520 of FIG. 5, an apparatus, such as apparatus 200, may be configured for classifying the geographic region, for example, comprising both the two or more merchant devices and the area meeting at least the predefined threshold number of mobile devices required in a particular area for the particular area to be considered hot, as a hot zone.

It may be helpful to understand that a hot zone is ephemeral and not permanent. As such, in some embodiments, the area and/or the particular region may be considered hot (e.g., classified as a hot zone) while the number of the plurality of mobile devices that are located within the area or geographic region continues to meet the predefined threshold number of mobile devices required in the particular area for the particular area to be considered hot.

As described above, geographic regions classified as hot zones are non-permanent/ephemeral. As such, any use of the hot zone is time-limited. In some embodiments, while available (e.g., still classified as a hot zone, indicative of a high demand/high supply area), an apparatus, such as apparatus 200, may be configured for identifying promotions associated with merchants within hot zone, sending push notifications alerting at least one of the mobile device located therein to available promotions related to nearby products, services, experiences, or events. In some embodiments, an apparatus, such as apparatus 200, may be configured for determining which of a plurality of promotions to provide to a first mobile device, a second mobile device, etc. while observing availability limitations of each merchant.

While the apparatus makes use of the geographic regions classified as hot zones, the number of the plurality of devices located within the hot zone may be monitored to confirm the classification and identify or otherwise detect when the classification is no longer appropriate. As such, as shown in block 525 of FIG. 5, an apparatus, such as apparatus 200, may be configured for monitoring the number of the plurality of devices located within the hot zone. In some embodiments, for example where one or more merchants within the particular region are mobile, the number of merchant devices may be monitored also.

As described above, because hot zones are ephemeral, based on the monitoring of the number of mobile devices located therein, it may be determined that the threshold is not met any longer. Accordingly, as shown in block 530 of FIG. 5, an apparatus, such as apparatus 200, may be configured for determining that the number of the plurality of mobile devices that are located within the geographic region falls below or fails to meet the predefined threshold number of mobile devices required in the particular area for the particular area to be considered a hot zone.

Once this determination is made, the area and/or geographic region may no longer be considered a hot zone. As such, as shown in block 535 of FIG. 5, an apparatus, such as apparatus 200, may be configured for de-classifying the geographic region.

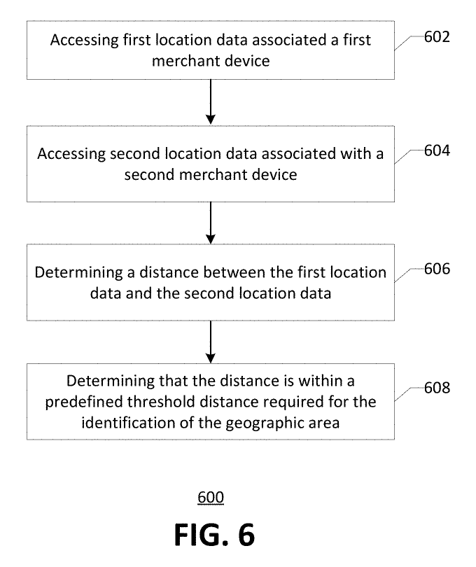

FIG. 6 illustrates a flow diagram depicting an example of a process 600 for identifying the number of mobile devices in an area, in accordance with some exemplary embodiments of the present invention. The process 600 illustrates how location data can be received from a plurality of merchant devices and determine congregations of those mobile devices. The process 600 may be performed by elements of an apparatus 200, such as location services circuitry 210 and/or geo-fencing circuitry 212 as described above with respect to FIG. 2.

As shown in block 605 of FIG. 6, an apparatus, such as apparatus 200, may be configured for accessing first location data associated a first merchant device, and subsequently, or in parallel, as shown in block 610 of FIG. 6, an apparatus, such as apparatus 200, may be configured for accessing second location data associated with a second merchant device. In some embodiments, each of a plurality of merchant devices within a particular neighborhood or the like are identified, for example, for the determination of the geo-fenced geographic region.

One of ordinary skill would appreciate that this is an iterative process and may include any number of merchant devices, each having an identifiable location. As shown in block 615 of FIG. 6, an apparatus, such as apparatus 200, may be configured for determining a distance between the first location data and the second location data. In some embodiments, the apparatus may not determine the distance on an absolute basis, but may instead identify the proximity based on, for example, connection to the same or similar wireless networks, or the like. Once the proximately is determined, as shown in block 620 of FIG. 6, an apparatus, such as apparatus 200, may be configured for determining that the distance is within a predefined threshold distance required for the identification of the geographic region. Upon the determination of a geographic region comprising a plurality of merchants, an indication of the geographic region may be stored in a database, for example, geo-fencing data 310 shown in FIG. 3, which may, for example, later be used in the identification of a hot zone.

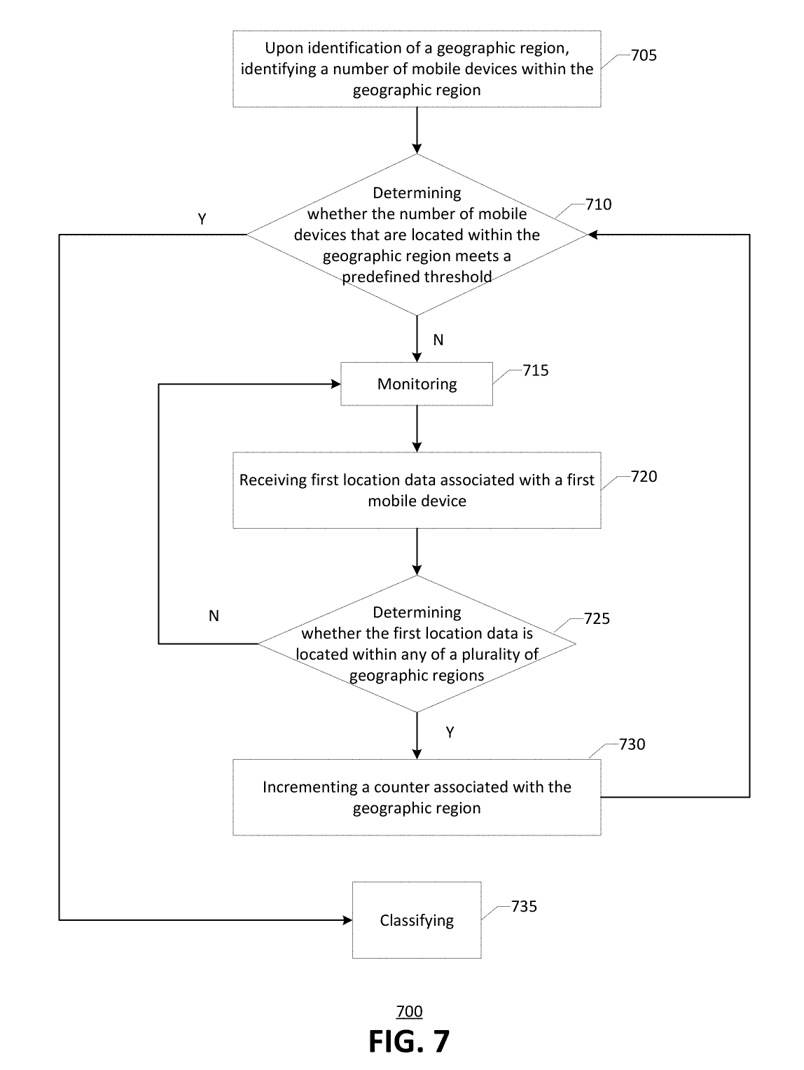

FIG. 7 illustrates a flow diagram depicting an example of a process 700 for classifying a geographic region comprising a plurality of merchants that also comprises a number of mobile devices located therein meeting a threshold, as a hot zone, in accordance with some exemplary embodiments of the present invention. The process 600 illustrates how upon identification of geographic region comprising a plurality of merchants may be determined to be a hot zone by monitoring location data received from a plurality of mobile devices to determine congregations of those mobile devices within the geographic region. The process 700 may be performed by elements of an apparatus 200, such as location services circuitry 210 and/or geo-fencing circuitry 212 as described above with respect to FIG. 2.

In some embodiments, a geographic regions is identified. For example, as described above, a geographic region may comprise a plurality of merchants and/or service providers. In some embodiments, a geographic region may be identified as a geo-fenced area, such as a circle with a pre-defined radius around a particular merchant. While in other embodiments, a geographic regions may be a geo-fenced area, such as an ellipse or the like where at least two particular merchants are focal points. In other embodiments, a geographic regions may be a geo-fenced area enclosing a particular neighborhood or portion thereof that contains a particular merchant.

In any event, once a geographic regions is identified, as shown in block 705 of FIG. 7, an apparatus, such as apparatus 200, may be configured for, upon identification of a geographic region, identifying a number of mobile devices within the geographic region. Subsequently, as shown in block 710 of FIG. 7, an apparatus, such as apparatus 200, may be configured for determining whether the number of mobile devices that are located within the geographic region meets a predefined threshold, for example, for identifying the geographic regions as a hot zone and/or, in some embodiments, for determining whether the demand (e.g., as inferred by the number of mobile devices) is indicative of a need for additional supply (e.g., as inferred by the number of merchants located therein).

In an instance in which the number of mobile devices that are located within the geographic region fails to meet a predefined threshold, as shown in block 715 of FIG. 7, an apparatus, such as apparatus 200, may be configured for monitoring for additional mobile devices. Upon the detection or identification of new or previously unknown or undetected location data indicative of a mobile device, as shown in block 720 of FIG. 7, an apparatus, such as apparatus 200, may be configured for receiving first location data associated with a first mobile device. Once received, as shown in block 725 of FIG. 7, an apparatus, such as apparatus 200, may be configured for determining whether the first location data is located within any of a plurality of geographic regions.

In an instance in which the first location data is located within at least one of the geographic regions, as shown in block 730 of FIG. 7, an apparatus, such as apparatus 200, may be configured for incrementing a counter associated with the geographic region. Once the counter is incremented, once again, as shown in block 710 of FIG. 7, an apparatus, such as apparatus 200, may be configured for determining whether the number of mobile devices that are located within the geographic region meets a predefined threshold. Upon a determination that the number of mobile devices that are located within the geographic region meets a predefined threshold, as shown in block 735 of FIG. 7, an apparatus, such as apparatus 200, may be configured for classifying the geographic region as a hot zone.

Additionally or alternatively, in some embodiments the system may identify an aggregation of mobile devices (e.g., where greater than a threshold number of consumer devices are detected in proximity with one another) by querying or otherwise contacting a wireless service provider. For example, upon determination or identification of a geographic region comprising a plurality of merchant devices, the system may identify a latitude and longitude coordinate associated with the geographic region, and/or identify a region within a certain radius of those coordinates. This regions may then be used to access or otherwise provided, for example, as a set of map data, to a wireless carrier system to identify the particular devices contained therein. In some embodiments, wireless carrier systems have users that have “opted in” to wireless carrier provided location information to allow the process to obtain the location of devices that are not otherwise configured to directly provide location information to the system. For example, the system may be configured to initiate a request to the wireless carrier, such as by requesting from the carrier a list of mobile devices that have “opted in” and which are located within a particular geographic region and/or proximate to a particular location and, in return receive a list of mobile devices from the carrier, for example for use in the identification of a hot zone.

As will be appreciated, computer program code and/or other instructions may be loaded onto a computer, processor or other programmable apparatus's circuitry to produce a machine, such that execution of the code on the machine by the computer, processor, or other circuitry creates the means for implementing various functions, including those described herein.

As described above and as will be appreciated based on this disclosure, embodiments of the present invention may be configured as methods, mobile devices, backend network devices, and the like. Accordingly, embodiments may comprise various means including entirely of hardware or a combination of software and hardware. Furthermore, embodiments may take the form of a computer program product on at least one computer-readable storage medium having computer-readable program instructions (e.g., computer software) embodied in the storage medium. Any suitable computer-readable storage medium may be utilized, including non-transitory hard disks, CD-ROMs, flash memory, optical storage devices, magnetic storage devices, or the like.

Embodiments of the present invention have been described above with reference to block diagrams and flowchart illustrations of methods, apparatuses, systems and computer program products. It will be understood that each block of the circuit diagrams and process flowcharts, and combinations of blocks in the circuit diagrams and process flowcharts, respectively, can be implemented by various means including computer program instructions. These computer program instructions may be loaded onto a general purpose computer, special purpose computer, or other programmable data processing apparatus to produce a machine, such that the computer program product includes the instructions which execute on the computer or other programmable data processing apparatus create a means for implementing the functions specified in the flowchart block or blocks.

These computer program instructions may also be stored in a computer-readable storage device that can direct a computer or other programmable data processing apparatus to function in a particular manner, such that the instructions stored in the computer-readable storage device produce an article of manufacture including computer-readable instructions for implementing the function discussed herein. The computer program instructions may also be loaded onto a computer or other programmable data processing apparatus to cause a series of operational steps to be performed on the computer or other programmable apparatus, thereby producing a computer-implemented process such that the instructions executed on the computer or other programmable apparatus cause performance of the steps and thereby implement the functions discussed herein.

Accordingly, blocks of the block diagrams and flowchart illustrations support combinations of means for performing the specified functions, combinations of steps for performing the specified functions and program instruction means for performing the specified functions. It will also be understood that each block of the circuit diagrams and process flowcharts, and combinations of blocks in the circuit diagrams and process flowcharts, can be implemented by special purpose hardware-based computer systems that perform the specified functions or steps, or combinations of special purpose hardware and computer instructions.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for identifying geographic areas having elevated supply and demand levels based on an elevated number of service providers and mobile devices in a geographic area utilizing location services, the method comprising:
identifying a geographic region comprising a pre-defined number of merchant devices;
receiving location data associated with a plurality of mobile devices;
determining that the number of the plurality of mobile devices that are located within an area located within at least the geographic region comprising the pre-defined number of merchant devices meets a predefined threshold number of mobile devices required in a particular area for the particular area to be considered hot; and
classifying the geographic region, comprising both the pre-defined number of merchant devices and the area meeting at least the predefined threshold number of mobile devices required in a particular area for the particular area to be considered hot, as a hot zone while the number of the plurality of mobile devices that are located within the continues to meet the predefined threshold number of mobile devices required in a particular area for the particular area to be considered hot.

2. The method of claim 1, wherein the identification of the geographic region comprises: accessing first location data associated a first merchant device; accessing second location data associated with a second merchant device; and determining a distance between the first location data and the second location data; and determining that the distance is within a predefined threshold distance required for the identification of the geographic area.

3. The method of claim 1, wherein the determination comprises: receiving first location data, identifying whether the first location data is located within any of a plurality of the geographic regions, in an instance in which the first location data is located within one of the plurality of geographic regions, incrementing a counter associated with the geographic region, determining if the counter meets the predefined threshold, and in an instance in which the counter has meet the predefined threshold, classifying the geographic region.

4. The method of claim 1, wherein the determination comprises: upon identification of at least one the geographic region, identifying a number of mobile devices within the at least one geographic region, in an instance in which the number of mobile devices within the at least one geographic threshold fails to meet the predefined threshold, monitoring for additional mobile device, upon identification of a new mobile device within the at least one geographic regions, receiving new location data, increment a counter associated with the number of mobile devices with the at least one geographic regions, iterate the identification, monitoring, receiving and incrementing steps, and in an instance in which the number of mobile devices within the at least one geographic threshold meets the predefined threshold, classifying the geographic region.

5. The method of claim 1, wherein the determination comprises: accessing first location data associated with a first mobile device, accessing an aggregation queue storing location data associated with each of the plurality of mobile devices, determining a number mobile devices located within a threshold distance to the first mobile device, and in an instance in which the number of mobile devices within the at least one geographic threshold meets the predefined threshold, classifying the geographic region.

6. The method of claim 1, further comprising: identifying promotions associated with merchants within hot zone, send push notifications alerting a mobile device to available promotions related to nearby products, services, experiences, or events.

7. The method of claim 6, further comprising: determining which of a plurality of promotions to provide to a first mobile device and to a second mobile device, while observing availability limitations of each merchant.

8. The method of claim 1, further comprising: monitoring the number of the plurality of mobile devices located within the geographic regions classified as a hot zone; and upon a determination that the number of the plurality of mobile devices that are located within the geographic area falls below or fails to meet the predefined threshold number of mobile devices required in the particular area for the particular area to be considered the hot zone, declassifying the geographic region.

9. A computer program product for identifying geographic areas having elevated supply and demand levels based on an elevated number of service providers and mobile devices in a geographic area utilizing location services, the computer program product comprising at least one non-transitory computer-readable storage medium having computer-executable program code instructions stored therein, the computer-executable program code instructions comprising program code instructions for:
identifying a geographic region comprising a pre-defined number of merchant devices;
receiving location data associated with a plurality of mobile devices;
determining that the number of the plurality of mobile devices that are located within an area located within at least the geographic region comprising the pre-defined number of merchant devices meets a predefined threshold number of mobile devices required in a particular area for the particular area to be considered hot; and
classifying the geographic region, comprising both the pre-defined number of merchant devices and the area meeting at least the predefined threshold number of mobile devices required in a particular area for the particular area to be considered hot, as a hot zone while the number of the plurality of mobile devices that are located within the continues to meet the predefined threshold number of mobile devices required in a particular area for the particular area to be considered hot.

10. The computer program product of claim 9, wherein the identification of the geographic region comprises: accessing first location data associated a first merchant device; accessing second location data associated with a second merchant device; and determining a distance between the first location data and the second location data; and determining that the distance is within a predefined threshold distance required for the identification of the geographic area.

11. The computer program product of claim 9, wherein the determination comprises: receiving first location data, identifying whether the first location data is located within any of a plurality of the geographic regions, in an instance in which the first location data is located within one of the plurality of geographic regions, incrementing a counter associated with the geographic region, determining if the counter meets the predefined threshold, and in an instance in which the counter has meet the predefined threshold, classifying the geographic region.

12. The computer program product of claim 9, wherein the determination comprises: upon identification of at least one the geographic region, identifying a number of mobile devices within the at least one geographic region, in an instance in which the number of mobile devices within the at least one geographic threshold fails to meet the predefined threshold, monitoring for additional mobile device, upon identification of a new mobile device within the at least one geographic regions, receiving new location data, increment a counter associated with the number of mobile devices with the at least one geographic regions, iterate the identification, monitoring, receiving and incrementing steps, and in an instance in which the number of mobile devices within the at least one geographic threshold meets the predefined threshold, classifying the geographic region.

13. The computer program product of claim 9, wherein the determination comprises: accessing first location data associated with a first mobile device, accessing an aggregation queue storing location data associated with each of the plurality of mobile devices, determining a number mobile devices located within a threshold distance to the first mobile device, and in an instance in which the number of mobile devices within the at least one geographic threshold meets the predefined threshold, classifying the geographic region.

14. The computer program product of claim 9, wherein the computer-executable program code instructions further comprise program code instructions for: identifying promotions associated with merchants within hot zone, send push notifications alerting a mobile device to available promotions related to nearby products, services, experiences, or events.

15. The computer program product of claim 14, wherein the computer-executable program code instructions further comprise program code instructions for: determining which of a plurality of promotions to provide to a first mobile device and to a second mobile device, while observing availability limitations of each merchant.

16. The computer program product of claim 9, wherein the computer-executable program code instructions further comprise program code instructions for: monitoring the number of the plurality of mobile devices located within the geographic regions classified as a hot zone; and upon a determination that the number of the plurality of mobile devices that are located within the geographic area falls below or fails to meet the predefined threshold number of mobile devices required in the particular area for the particular area to be considered the hot zone, declassifying the geographic region.

17. An apparatus for identifying geographic areas having elevated supply and demand levels based on an elevated number of service providers and mobile devices in a geographic area utilizing location services, the apparatus comprising at least one processor and at least one memory including computer program code, the at least one memory and the computer program code configured to, with the processor, cause the apparatus to at least:
identify a geographic region comprising a pre-defined number of merchant devices;
receive location data associated with a plurality of mobile devices;
determine that the number of the plurality of mobile devices that are located within an area located within at least the geographic region comprising the pre-defined number of merchant devices meets a predefined threshold number of mobile devices required in a particular area for the particular area to be considered hot; and
classify the geographic region, comprising both the pre-defined number of merchant devices and the area meeting at least the predefined threshold number of mobile devices required in a particular area for the particular area to be considered hot, as a hot zone while the number of the plurality of mobile devices that are located within the continues to meet the predefined threshold number of mobile devices required in a particular area for the particular area to be considered hot.

18. The apparatus of claim 17, wherein the identification of the geographic region comprises: accessing first location data associated a first merchant device; accessing second location data associated with a second merchant device; and determining a distance between the first location data and the second location data; and determining that the distance is within a predefined threshold distance required for the identification of the geographic area.

19. The apparatus of claim 17, wherein the determination comprises: receiving first location data, identifying whether the first location data is located within any of a plurality of the geographic regions, in an instance in which the first location data is located within one of the plurality of geographic regions, incrementing a counter associated with the geographic region, determining if the counter meets the predefined threshold, and in an instance in which the counter has meet the predefined threshold, classifying the geographic region.

20. The apparatus of claim 17, wherein the determination comprises: upon identification of at least one the geographic region, identifying a number of mobile devices within the at least one geographic region, in an instance in which the number of mobile devices within the at least one geographic threshold fails to meet the predefined threshold, monitoring for additional mobile device, upon identification of a new mobile device within the at least one geographic regions, receiving new location data, increment a counter associated with the number of mobile devices with the at least one geographic regions, iterate the identification, monitoring, receiving and incrementing steps, and in an instance in which the number of mobile devices within the at least one geographic threshold meets the predefined threshold, classifying the geographic region.

21. The apparatus of claim 17, wherein the determination comprises: accessing first location data associated with a first mobile device, accessing an aggregation queue storing location data associated with each of the plurality of mobile devices, determining a number mobile devices located within a threshold distance to the first mobile device, and in an instance in which the number of mobile devices within the at least one geographic threshold meets the predefined threshold, classifying the geographic region.

22. The apparatus of claim 17, wherein the at least one memory and the computer program code are further configured to, with the processor, cause the apparatus to: identify promotions associated with merchants within hot zone, send push notifications alerting a mobile device to available promotions related to nearby products, services, experiences, or events.

23. The apparatus of claim 22, wherein the at least one memory and the computer program code are further configured to, with the processor, cause the apparatus to: determine which of a plurality of promotions to provide to a first mobile device and to a second mobile device, while observing availability limitations of each merchant.

24. The apparatus of claim 17, wherein the at least one memory and the computer program code are further configured to, with the processor, cause the apparatus to: monitor the number of the plurality of mobile devices located within the geographic regions classified as a hot zone; and upon a determination that the number of the plurality of mobile devices that are located within the geographic area falls below or fails to meet the predefined threshold number of mobile devices required in the particular area for the particular area to be considered the hot zone, declassify the geographic region.
